(19) United States
(12) Patent Application Publication
(10) Pub. No.: US 2017/0105369 A1
(43) Pub. Date: Apr. 20, 2017

(54) WIRELESS UTILITY METERING DEVICES, SYSTEMS, AND METHODS FOR IRRIGATION

(71) Applicant: Transparent Technologies, Inc, Boulder, CO (US)

(72) Inventors: Mark Shamley, Broomfield, CO (US); Matt Laird, Boulder, CO (US)

(73) Assignee: Transparent Technologies, Inc, Boulder, CO (US)

(21) Appl. No.: 15/294,360

(22) Filed: Oct. 14, 2016

Related U.S. Application Data
(60) Provisional application No. 62/241,750, filed on Oct. 14, 2015.

(51) Int. Cl. A01G 25/16; G05B 19/042; G05D 7/06

(52) U.S. Cl. CPC A01G 25/16; G05D 7/0635; G05B 19/042; G05B 2219/2625

(57) ABSTRACT

Wireless utility metering devices, systems, and methods for irrigation, involving a processor, a power source in electronic communication with the processor; a feature for wirelessly communicating, the wirelessly communicating feature in electronic communication with the processor and the power source; and an irrigation feature, such as a virtual irrigation deduction meter feature, a residential consumption profile feature, a residential irrigation profile feature, and a restricted irrigation compliance monitoring feature. The processor controls the wirelessly communicating feature and the irrigation feature in a manner that minimizes water consumption, whereby water is conservable, and whereby the electronic device being adapted to serve at least one function. The multifunction electronic device serves at least one function, such as a register device or a remote device. The multifunction electronic device wirelessly communicates with a remote server, such as a cloud-based server, and performs metering measurements by way of a magnetic field sensor for enhancing accuracy of such measurements.

### CROSS REFERENCE TO RELATED APPLICATIONS

This application claims the benefit of U.S. Provisional Patent Application No. 62/241,750, filed on Oct. 14, 2015, also titled “Wireless Utility Metering Devices, Systems, and Methods for Irrigation” which is incorporated by reference herein in its entirety for all purposes.

### TECHNICAL FIELD

The present disclosure relates to “green” or “eco-friendly” (ecologically-friendly) technologies for metering water usage. More specifically, the present disclosure relates to green technologies for metering water usage in the field, such as in an irrigation environment. Even more specifically, the present disclosure relates to green technologies for wirelessly metering water usage in the field, such as in an irrigation environment.

### BACKGROUND

Many related art technologies are currently utilized for metering water usage. One of the greatest challenges in the related art is development of a smart meter system, e.g., in the machine-to-machine market, where human interaction has been eliminated from the communications. One problem experienced in the related art smart meters is that the currently available chipsets do not perform sufficiently for low-power, primary-cell battery applications. Another problem experienced in the related art is that conventional water meters take readings that are compiled into daily usage data, thereby comingling domestic water usage data with irrigation water usage data. Typically, related art utility companies must use two meters to determine a ratio in order to determine the sewer taxes for run off irrigation water, thereby introducing inefficiencies in data collection as well as undue cost.

Typical related art water meters also use a pair of magnets to drive a mechanical odometer. For example, a related art register is attached to conventional water meters, wherein a second magnet is used to track a first magnet of the meter (not shown), in accordance with the related art. Almost all water meters for at least the past fifty (50) years use a magnetic drive. The measuring element in the water meter is coupled with the magnet at the top of the meter housing. A corresponding magnet is disposed in the mechanical register. When these two magnets couple, and the measuring element essentially pulls the upper magnet as well as the connected register gear train and odometer wheels. This related art technique for tracking water consumption results in introducing drag and other frictional forces on the measuring element, thereby greatly reducing accuracy, especially low flow accuracy. This drag effect worsens with age of the water meter and continuing exposure to the environment. The number of gears and odometer wheels in the register add to the drag and other frictional forces, which means that most manufacturers of such related art devices are limited to the number of wheels, whereby the resolution of the register is greatly reduced, thereby providing information that is less useful.

For instance, many other related art smart meters wirelessly transmit usage data, use a conventional magnetic sensor or a conventional flow sensor for evaluating the water flow, and use lithium batteries as a power source. Some related art smart meters wirelessly transmit and receive data via a wireless network and store data stored concerning fluid usage. Other related art smart meters involve electrodes for monitoring flow rates, a resource management system with wireless access nodes for monitoring, diagnostics, and billing, the wireless access nodes for facilitating communication with a central server; a credit value sub-unit, a remotely addressable shut-off valve, and an irrigation management system using wireless transceivers for communication between providers and users.

While these background examples may relate to mechanical water meters and first generation smart meter technologies, in general, they fail to disclose a smart meter device or a smart meter system that conserves water consumption, especially irrigation water consumption. As such, a long-felt need has been experienced in the related art for large-scale smart meter devices, systems, and methods that overcome the inherent inefficiencies of the related art dual-meter configurations and that provide improved accuracy in meter readings, e.g., higher resolution readings.

### SUMMARY

In addressing many of the problems experienced in the related art, such as the inherent inefficiencies of the dual-meter configurations and inaccurate low resolution meter readings, the present disclosure generally involves a multi-function electronic device, such as a register device, adapted for wireless communication with a remote server, a remote device adapted for wireless communication with a remote server, a system comprising a multifunction electronic device, as well as corresponding methods of fabrication and use for such devices and system. In addition, the multifunction electronic device, serving as a register device, utilizes a sensor, rather than a magnet, to track the meter, whereby more accurate readings are provided. Further, the electronic device further provides other features, such as a graphic user interface (GUI) for displaying a flow-rate display, facilitating data-logging, and providing a plurality of output options.

Further, the multi-function electronic device, serving as a register device, generally comprises a magnetic field sensor and a microcontroller, in accordance with the present disclosure. The magnetic field sensor does not introduce any drag on the meter magnet, thereby facilitating increasing efficiency of a measuring element. Also, the magnetic field sensor transmits signals that correspond to actual turns of the meter magnet to the microcontroller, thereby increasing the resolution for data-logging and data functions. The multi-function electronic device includes, but is not limited to, the following benefits: increasing resolution of data by recording every meter magnet turn, restoring and improving low-flow accuracy by improving measurement performance, providing universal compatibility with most common residential or commercial water meters, and enhancing revenues by improving data accuracy.

Alternatively, a multi-function electronic device is adapted to serve, not only as a register device, but also as a remote device, for interfacing with a fluid metering body, such as a conventional water meter. The multi-function electronic device, when used as a register device, is disposable in relation to the fluid metering body, e.g., via attachment or placement at a location proximal the fluid metering body, the fluid metering body having a magnet that spins when experiencing a fluid flow, the register device serving as both a register (index) and a wireless communications device. The multi-function electronic device, when used as a remote device, is disposable in relation to a fluid metering body register via hard wires, querying data from the fluid metering body register and serving as the communications device. The multi-function electronic device has an LCD as the primary user interface and is used primarily by public or private water utilities for use in metering, meter reading, customer service, and providing advanced data analytics. In addition, the multi-function electronic device utilizes a low power microcontroller for controlling all circuitry and functions.

In general, the multi-function electronic device, when used as a register device, monitors the rotation of a magnet on the measuring element of a fluid metering body by way of a magnetic sensor. The register device comprises a digitization circuit, utilizing a high-resolution state chart algorithm, for facilitating tracking a forward flow and a reverse flow, an anti-aliasing filter with an advanced algorithm for detecting a fluid metering body register removal or a magnetic tampering. Algorithms are used for basic consumption counting, flow rate conversion, and measurement testing.

Unlike many related art devices, rather than using a coupling magnet, the multi-function electronic device, when used as a register device, utilizes a field magnetic sensor to detect the motion of the magnet in the meter, in accordance with the present disclosure. The electronic device has a microcontroller that employs a state machine algorithm to track each 1/16^{th} of a magnet's turn. The algorithm also determines the direction of the turn clockwise (CW) or counter-clockwise (CCW). The sensor does not exert any drag on the meter's measuring element. As such, the multi-function electronic device, when used with a water meter, provides better low-flow accuracy than does a typical water meter's original (OEM) mechanical register. The sensor also transmits very high-resolution consumption information, e.g., approximately less than 1/100^{th} of a gallon, to the microcontroller for applying its data algorithms and logging.

In general, the multi-function electronic device, when used as a remote device, is capable of coupling with a multitude of fluid metering body registers through common wired interfaces. The remote device is queried for the consumption data. Tamper detection circuitry provides indication of a cut cable or malfunctioning fluid metering body register. In particular, the multi-function electronic device has also implemented two circuits or functions for handling potential tampering of the fluid metering body. With a related art magnetic sensor, an unscrupulous end-consumer of water, e.g., an unscrupulous homeowner, or an unscrupulous business-owner, could possibly use a very strong magnet to impede the related art sensor's operations. To combat this conduct, the multi-function electronic device offers an additional layer of security to the utility provider by implementing a dynamic register and tamper-detection system in combination with a specialized magnetic field sensor. The signals from the magnetic sensor of the present disclosure are transmitted through an analog-to-digital converter (ADC) and analyzed with routines in the microcontroller. From the analysis, the multi-function electronic device determines whether the meter register has been removed from the fluid metering body or if a tampering magnetic field is present.

As a register device, the multi-function electronic device utilizes high-resolution data from the sensor to log consumption in non-volatile memory (EEPROM). This data can be stored in increments as low as one minute. As a remote device, the multi-function electronic device utilizes the data returned or counted from the connected fluid metering body register to log consumption in the memory. The resolution of the data is dependent upon the fluid metering body register. The register device has an infrared port for local communications. This port can be used for reading, configuration, diagnostics, and boot-loading. With respect to data-logging, consumption data for individual accounts is useable for many purposes, including leak detection, conservation monitoring, and customer service interface. In the water utility industry, the water meter register only provides the current read (index) of the meter and is queried by an advanced meter reader (AMR) device or an advanced metering infrastructure (AMI) device that then stores or transmits the data. With the multi-function electronic device of the present disclosure, high-resolution data is storable on board, e.g., by way of the EEPROM, wherein the stored data is useable for on-board algorithms, such as leak detection, high-usage monitoring, conservation monitoring, back-flow detection, and zero usage monitoring, and the like. This stored data is accessible at any time for immediate use, e.g., for a customer service review, and also serves as data backup for the AMI system. In the multi-function electronic device, an AMR device is optionally embedded.

The multi-function electronic device accommodates new firmware that is loaded (boot-loaded) through either the infrared port or the wireless communication module through the infrared port, the boot-loader interfaces to a handheld or tablet computer. Through the wireless communication module, the boot-loader interfaces to the remote service. Firmware corrections or new algorithms can be loaded via this boot-loader.

The multi-function electronic device has a wireless communication module that is used for data reporting to a remote server. The wireless communication module allows for deployment in a variety of existing wireless networks. The existing cellular network provides a network for all communications back to a remote server. The multi-function electronic device, therefore, does not require additional network equipment or infrastructure for communication. The multi-function electronic device, comprising a wireless module, e.g., a cellular module, is also embeddable within water meter register and has several advantages. The use of an existing cellular network by the multi-function electronic device provides significant business advantages.

The multi-function electronic device also uses configurable algorithms for consumption analysis. The high-resolution data-logging allows the multi-function electronic device to track common consumption patterns, such as leaks, zero-usage, high usage, and backflow. When one of these patterns is detected, a flag is set in memory and is then sent within the wireless daily broadcast. In this method, the multi-function electronic device pre-processes the data for the utility. The sent flags allow automatic reporting and notifications.

In accordance with an embodiment of the present disclosure, an electronic device, comprises: a processor; a power source in electronic communication with the processor; a feature for wirelessly communicating, the wirelessly communicating feature in electronic communication with the processor and the power source; and at least one irrigation feature of a virtual irrigation deduction meter feature, a residential consumption profile feature, a residential irrigation profile feature, and a restricted irrigation compliance monitoring feature, the at least one irrigation feature in electronic communication with the processor and the power source, the processor adapted to control the wirelessly communicating feature and the at least one irrigation feature in a manner that minimizes water consumption, whereby water is conservable, and whereby the electronic device being adapted to serve at least one function, such as a register device and a remote device. The wirelessly communicating feature comprises a cellular feature for communicating utility usage data to a server, such as a remote server, a cloud-based server, and a remote cloud-based server.

In accordance with another embodiment of the present disclosure, a wireless system comprises: at least one electronic device in communication with at least one server, the at least one electronic device, comprising: a processor; a power source in electronic communication with the processor; a feature for wirelessly communicating, the wirelessly communicating feature in electronic communication with the processor and the power source; and at least one irrigation feature of a virtual irrigation deduction meter feature, a residential consumption profile feature, a residential irrigation profile feature, and a restricted irrigation compliance monitoring feature, the at least one irrigation feature in electronic communication with the processor and the power source, the processor adapted to control the wirelessly communicating feature and the at least one irrigation feature in a manner that minimizes water consumption, whereby water is conservable, and whereby the electronic device being adapted to serve at least one function, such as a register device and a remote device. The wirelessly communicating feature comprises a cellular feature for communicating utility usage data to a server, such as a remote server, a cloud-based server, and a remote cloud-based server.

In accordance with yet another embodiment of the present disclosure, a method of handling utility usage data by way of a multi-function electronic device comprises: collecting utility usage data by at least one magnetic-field sensor; and transmitting the utility usage data to at least one server by a wireless communicating feature, wherein the collecting step comprises utilizing at least one irrigation feature of a virtual irrigation deduction meter feature, a residential consumption profile feature, a residential irrigation profile feature, and a restricted irrigation compliance monitoring feature, wherein the at least one irrigation feature utilizing step comprises controlling the at least one irrigation feature by the processor in a manner that minimizes water consumption, and whereby water is conservable.

In accordance with still yet another embodiment of the present disclosure, an electronic device comprises: a processor; a power source in electronic communication with the processor; and at least one magnetic-field sensor in electronic communication with the processor; and at least one irrigation feature of a virtual irrigation deduction meter feature, a residential consumption profile feature, a residential irrigation profile feature, and a restricted irrigation compliance monitoring feature, the at least one irrigation feature in electronic communication with the processor and the power source, the processor adapted to control the at least one irrigation feature in a manner that minimizes water consumption, whereby water is conservable, and whereby the electronic device being adapted to serve at least one function.

The multi-function electronic devices, systems, and methods of the present disclosure further comprise features for detecting, displaying, and controlling usage of irrigation water, e.g., which may be subject to sewer taxes and/or water use limitation regulations, in accordance with the present disclosure. In these embodiments of the present disclosure, the multi-function electronic devices, systems, and methods involve detecting detailed information relating to irrigation water usage, hitherto unobtainable in the relater art, by measuring the water usage data at sub-hourly intervals, thereby facilitating determination of irrigation water usage.

The multi-function electronic devices, systems, and methods also utilize a combination of high-resolution data, e.g., in a range less than approximately 1 gallon, and short reading intervals, e.g., in a range less than approximately 1 hour, in accordance with the present disclosure. The multi-function electronic devices, systems, and methods further utilize at least the following irrigation features: a virtual irrigation deduction meter feature, a residential consumption profile feature, a residential irrigation profile feature, and a restricted irrigation compliance monitoring feature, in accordance with the present disclosure.

With respect to the virtual irrigation deduction meter feature, by using short interval data, identifying the irrigation water usage from a periodic higher flow rate usage is possible. This identification of the irrigation water usage is important, because lawns are typically watered for durations in a range less than approximately an hour and possibly watered region-by-region (in relation to portions of the lawn) over different time periods of a day, e.g., in 15-minute intervals at each region of a plurality of regions (imparting data for determining a short-interval peak usage). In the methods of the present disclosure, this short-interval peak usage is summed to provide a total short-interval peak usage value. Any leakage usage is subtracted from the total short-interval peak usage value, thereby providing a net irrigation water usage value. This net irrigation water usage value is deducted from the total meter usage value in order to separate a “domestic” usage value for billing in relation to the items attributed to both “water and sewer” from the “irrigation water” usage for billing in relation to irrigation water usage only. By implementing this method of operating the presently disclosed multi-function electronic devices, and systems, implementation of a single water meter for measuring both domestic water usage as well as irrigation water usage is possible, rather than implementing two separate water meters, otherwise necessitated in the related art.

With respect to the residential consumption profile feature, a leak is determinable if the measured consumption, during a given interval for a given day, is zero, in accordance with the present disclosure. If no zero usage interval is found, then the “leak rate” is the lowest usage in any interval, normalized to a daily usage, a weekly usage, or a monthly usage. The irrigation usage is determined by summing the usage, above a predetermined threshold flow rate, over a certain period of time, e.g., a day, a week, or a month, to determine the total irrigation usage. The domestic usage is the total usage through the meter, minus the leak usage, and minus the irrigation usage. A residential consumption profile may be represented in a graphic form, e.g., as a percentage, a volume, or a currency (given a valid utility billing rate), over a certain time period, e.g., a day, a week, a month, or a year).

With respect to the residential irrigation profile feature, water consumers can see a daily, a weekly, or a monthly irrigation water usage being registered on their respective water meters by day, or even by sub-hourly intervals, in accordance with the present disclosure. The residential irrigation profile feature is adapted to correlate data in relation to any sprinkler system being active during these sub-hourly intervals, thereby providing the consumer with information relating to the amount of water being consumed at each location of the consumer's property. This is important to compare assumed sprinkler system programming to actual sprinkler system usage. The irrigation profile can show both irrigation volume (gallons) per day as well as irrigation time (minutes) per day.

With respect to the restricted irrigation compliance monitoring feature, this feature facilitates compliance with the plethora of regulations that are imposed by water utility companies for decreasing total water usage. Examples of such restrictions include, but are not limited to, limiting irrigation to certain days of the week, to certain times of the day, or to a maximum duration per irrigation event. Compliance with any of these restrictions is monitored via the restricted irrigation compliance monitoring feature by comparing the above irrigation profile to a given restriction. Further, the restricted irrigation compliance monitoring feature is adapted to identify violators of such restrictions for facilitating their penalization. Additionally, irrigation usage may be limited remotely, thereby eliminating the need for a service person to manually limit the water usage.

### DESCRIPTION OF THE DRAWING

The above, and other, aspects, features, and advantages of several embodiments of the present disclosure will be more apparent from the following Detailed Description as presented in conjunction with the following several figures of the Drawing.

FIG. 1 is a pictorial diagram illustrating a perspective view of a multi-function electronic device, comprising at least one irrigation feature in electronic communication with a processor and a power source, whereby water is conservable, and whereby the electronic device is adapted to serve at least one function, in accordance with an embodiment of the present disclosure.

FIG. 2 is a schematic diagram illustrating a multi-function electronic device, serving as a remote device, comprising a wireless communication module, in accordance with an embodiment of the present disclosure.

FIG. 3 is a schematic diagram illustrating a wireless system, comprising a multi-function electronic device, for facilitating utility metering, in accordance with an embodiment of the present disclosure.

FIG. 4 is a flow diagram illustrating a method of handling utility usage data by way of a multi-function electronic device, comprising utilizing at least one irrigation feature, in accordance with an embodiment of the present disclosure.

FIG. 5 is a flow diagram illustrating the irrigation feature utilizing step, comprising detecting an irrigation water usage, displaying the irrigation water usage, and controlling the irrigation water usage, in accordance with an embodiment of the present disclosure.

FIG. 6 is a flow diagram illustrating the irrigation feature utilizing step, comprising utilizing the virtual irrigation deduction meter feature, in accordance with an embodiment of the present disclosure.

FIG. 7 is a flow diagram illustrating the irrigation feature utilizing step, alternatively comprising utilizing the residential consumption profile feature, in accordance with an embodiment of the present disclosure.

FIG. 8 is a flow diagram illustrating the irrigation feature utilizing step, alternatively comprising utilizing a residential irrigation profile feature, in accordance with an embodiment of the present disclosure.

FIG. 9 is a flow diagram illustrating the irrigation feature utilizing step, alternatively comprising utilizing the restricted irrigation compliance monitoring feature, in accordance with an embodiment of the present disclosure.

FIG. 10 is screenshot illustrating a graphic user interface, comprising a display of meter history information, in accordance with an embodiment of the present disclosure.

FIG. 11 is a screenshot illustrating a graphic user interface, comprising a display of consumption analysis information, in accordance with an embodiment of the present disclosure.

Corresponding reference characters indicate corresponding components throughout the several figures of the Drawing. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

The multi-function electronic devices, systems, and methods comprise features for detecting, displaying, and controlling usage of irrigation water, e.g., which may be subject to sewer taxes and/or water use limitation regulations, in accordance with the present disclosure. In these embodiments of the present disclosure, the multi-function electronic devices, systems, and methods involve detecting detailed information relating to irrigation water usage, hitherto unobtainable in the related art, by measuring the water usage data at sub-hourly intervals, thereby facilitating determination of irrigation water usage.

The multi-function electronic devices, systems, and methods also utilize a combination of high-resolution data, e.g., in a range less than approximately 1 gallon, and short reading intervals, e.g., in a range less than approximately 1 hour, in accordance with the present disclosure. The multi-function electronic device, system, and methods further utilize at least the following features: a virtual irrigation deduction meter feature, a residential consumption profile feature, a residential irrigation profile feature, and a restricted irrigation compliance monitoring feature, in accordance with the present disclosure.

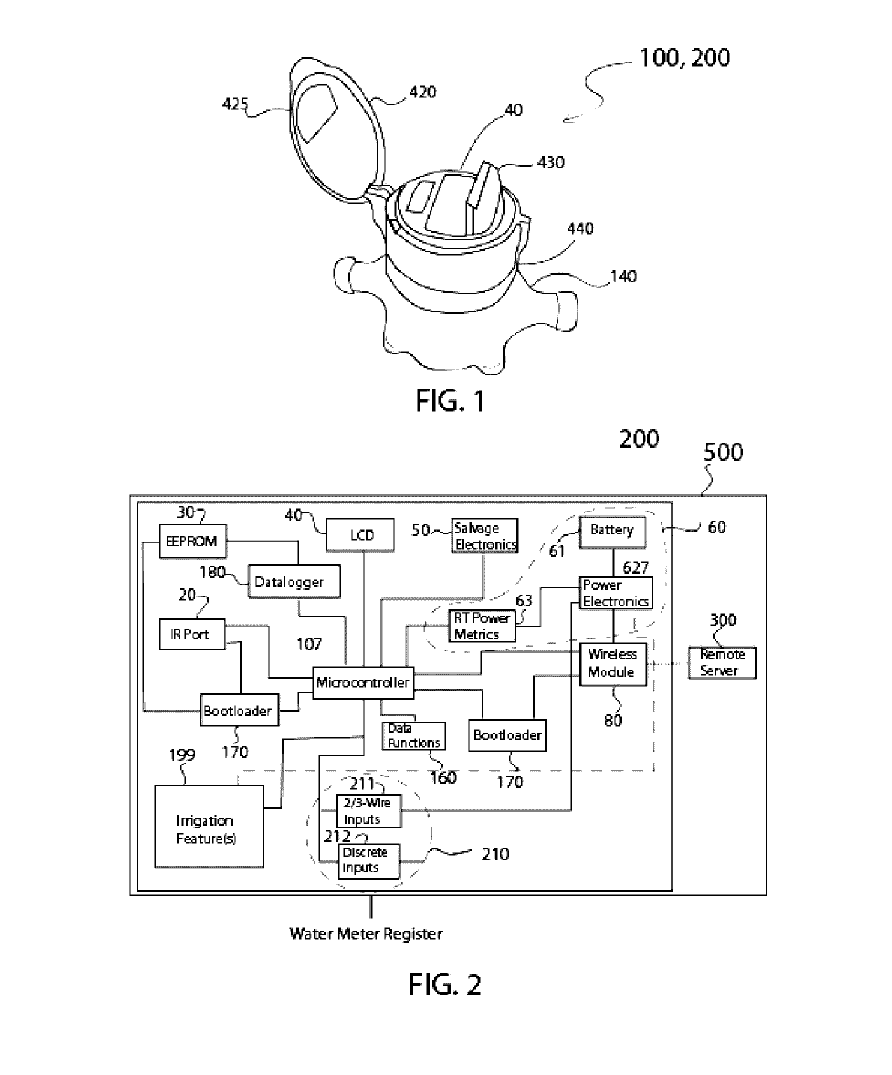

Referring to FIG. 1, this pictorial diagram illustrates, in a perspective view, an electronic device 100, comprising: a processor, such as a microcontroller 10 (FIG. 2); a power source, such as a power system 60 by way of power electronics 62 (FIG. 2) in electronic communication with the processor, e.g., the microcontroller 10; a feature for wirelessly communicating, such as a wireless module 80 (FIG. 2), the wirelessly communicating feature, e.g., the wireless module 80, in electronic communication with the processor, e.g., the microcontroller 10, and the power source, e.g., the power system 60 by way of power electronics 62; and at least one irrigation feature 199 (FIG. 2) of a virtual irrigation deduction meter feature (not shown), a residential consumption profile feature (not shown), a residential irrigation profile feature (not shown), and a restricted irrigation compliance monitoring feature (not shown), the at least one irrigation feature 199 in electronic communication with the processor, e.g., the microcontroller 10, and the power source, e.g., the power system 60 by way of power electronics 62, the processor, e.g., the microcontroller 10, adapted to control the wirelessly communicating feature, e.g., the wireless module 80, and the at least one irrigation feature 199 in a manner that minimizes water consumption, whereby water (not shown) is conservable, and whereby the electronic device is adapted to serve at least one function, such as functioning as a register device 100 and a remote device 200, in accordance with an embodiment of the present disclosure. The wirelessly communicating feature, e.g., the wireless module 80, comprises a cellular feature, such as an antenna 430, for communicating utility usage data to a server (FIG. 2), such as a remote server 300, a cloud-based server 301, and a remote cloud-based server (not shown).

Still referring to FIG. 1, the electronic device, serving as a register device 100, is adapted to wirelessly communicate with a remote server 300, such as in a wireless utilities metering system 500 (FIG. 2). The electronic device is shown as being mounted to a fluid metering body 140, by example only, and further comprises a lid 420 having an opening 425 for accommodating an antenna 430, such as an integral antenna, for facilitating visual access to the user interface 40, such as an LCD, and for providing access to the internal components of the electronic device 100. The LCD is further adapted to toggle between displaying total consumption data and flow rate data. The electronic device 100 comprises a housing 440. The lid 420 is mechanically coupled with the housing 440 in a manner such as being rotatably coupled. The electronic device 100 is further submersible and operable in an environmental temperature range of approximately −4° F. to approximately 176° F. or in an environmental temperature range of approximately −20° C. to approximately 80° C. The device 100 comprises a width in a range of approximately 3.12 in and a height of approximately 2.98 in.

Referring to FIG. 2, this schematic diagram illustrates the multi-function electronic device, serving as a remote device 200, comprising a wireless communication module, in accordance with an embodiment of the present disclosure. The remote device 200 is adapted to wirelessly communicate with a remote server 300. The remote device 200 further comprises a data-logger 180 for logging data for transmission to the EEPROM 30. All measured consumption data is then stored in the EEPROM 30 for transmission during a daily broadcast and for providing access thereto by the data functions module 160. The data-logger 180 comprises an embedded device that is adapted to simultaneously provide true leak analysis and peak flow analysis. The data logger 180 is further adapted to log data in a time interval of approximately 1 minute and to record fluid consumption with an accuracy of approximately 0.02 gallon. Further, the data-logger 180 is adapted to retrieve up to approximately 32,000 historical data points, e.g., by way of IR or 2-way RF channels for storage into an onboard log memory, corresponding to approximately 111 days at 5-min intervals.

Still referring to FIG. 2, the device 200 comprises: a processor, such as a microcontroller 10; a power source, such as a power system 60 by way of power electronics 62, in electronic communication with the processor, e.g., the microcontroller 10; a feature for wirelessly communicating, such as a wireless module 80, the wirelessly communicating feature in electronic communication with the processor, e.g., the microcontroller 10, and the power source, e.g., the power system 60 by way of the power electronics 62; and at least one irrigation feature 199 of a virtual irrigation deduction meter feature (not shown), a residential consumption profile feature (not shown), a residential irrigation profile feature (not shown), and a restricted irrigation compliance monitoring feature (not shown), the at least one irrigation feature 199 in electronic communication with at least one of the processor, e.g., the microcontroller 10, and the power source, e.g., the power system 60 by way of the power electronics 62, the processor, e.g., the microcontroller 10, adapted to control the wirelessly communicating feature, e.g., the wireless module 80, and the at least one irrigation feature 199 in a manner that minimizes water consumption, whereby water (not shown) is conservable, and whereby the electronic device 200 is adapted to serve at least one function. The wirelessly communicating feature, e.g., the wireless module 80, comprises a cellular feature, such as the antenna 430, e.g., an integral antenna, for communicating utility usage data to a server, such as a remote server 300, a cloud-based server 301, and a remote cloud-based server (not shown).

Still referring to FIG. 2, the device 200 alternatively comprises: a processor, e.g., a microcontroller 10; a power source, e.g., a power system 60 by way of power electronics 62, in electronic communication with the processor, such as the microcontroller 10; and at least one magnetic-field sensor (not shown), e.g., the at least one anisotropic magneto-resistive sensor, in electronic communication with the processor, such as the microcontroller 10; and at least one irrigation feature 199 of a virtual irrigation deduction meter feature (not shown), a residential consumption profile feature (not shown), a residential irrigation profile feature (not shown), and a restricted irrigation compliance monitoring feature (not shown), the at least one irrigation feature 199 in electronic communication with the processor, e.g., the microcontroller 10, and the power source, e.g., a power system 60 by way of power electronics 62, the processor, e.g., the microcontroller 10, adapted to control the at least one irrigation feature 199 in a manner that minimizes water consumption, whereby water (not shown) is conservable, and whereby the electronic device 200 is adapted to serve at least one function.

Still referring to FIG. 2, the wireless communication module 80 is used for data reporting to a remote server 300. The wireless communication module 80 allows for deployment in a variety of existing wireless networks. The existing cellular network provides a network for all communications back to a remote server. The multi-function electronic device, therefore, does not require additional network equipment or infrastructure for communication. The multi-function electronic device, comprising a wireless module 80, e.g., a cellular module, is also embeddable within water meter register and has several advantages. The use of an existing cellular network by the multi-function electronic device provides significant business advantages. Since most AMI manufacturers utilize proprietary RF techniques, these AMI manufacturers have full control of the physical layer and the protocol. The proprietary network typically requires the deployment of infrastructure, e.g., towers, aggregators/multiplexors, collectors, repeaters, etc., which is cost-prohibitive (both in deployment and in maintenance) and results in logistical difficulties for most utilities, since these infrastructure devices require vertical assets, e.g., building, poles, towers, etc., for optimal mounting locations. The utilization of an existing cellular network by the multi-function electronic device provides significant advantages, particularly the elimination of new infrastructure. The multi-function electronic device comprises a unique integration of a wireless module (M2M-type) into a battery-powered register device. The data handling of the transmission packet from a binary packet to an encoded data collection system, e.g., a cloud service, is also a difficult function in the related art. However, the multi-function electronic device of the present disclosure is adapted to receive 2-way messages/commands from a top-end system.

Still referring to FIG. 2, the data-logger 180, for example, performs onboard data-logging with the following data resolutions: at ⅝ in, the data resolution is in a range of approximately less than 0.02 gallons; at ¾ in, the data resolution is in a range of approximately less than 0.03 gallons; at 1 in, the data resolution is in a range of approximately less than 0.2 gallons; at 1.5 in, the data resolution is in a range of approximately less than 0.4 gallons; at 2 in, the data resolution is in a range of approximately less than 0.4 gallons; at 3 in, the data resolution is in a range of approximately less than 0.5 gallons; at 4 in, the data resolution is in a range of approximately less than 1.0 gallons; at 6 in, the data resolution is in a range of approximately less than 2.0 gallons; at 6 in, the data resolution is in a range of approximately less than 6.0 gallons; and at 8 in, the data resolution is in a range of approximately less than 6.0 gallons. The default data-logging interval is approximately 5 minutes; however, the multi-function device is programmable to set the interval in a range from approximately 1 minute to approximately 1 hour.

Still referring to FIG. 2, the multi-function electronic device, serving as a remote device 200, further comprises at least one input 210, wherein the at least one input is adapted to interface with at least one third-party advanced meter reader (AMR) device or advanced metering infrastructure (AMI) device (not shown). For example, the at least one input 210 comprises at least one element, such as a two-wire input or a three-wire input 211, and a discrete output 212. The two-wire input and the three-wire input 211 comprise a serial input which provides a pseudo-standard interface to third-party AMR/AMI devices, such as encoded-type water meter registers. The discrete input 212 provides an interface that is compatible with some older AMR devices, comprising switch closures and using active pulses, which output discrete signals, such as switch closures and active pulses (generators). In a preferred embodiment, further comprises a plurality of inputs, wherein the plurality of inputs is adapted to interface with a plurality of third-party AMR/AMI devices.

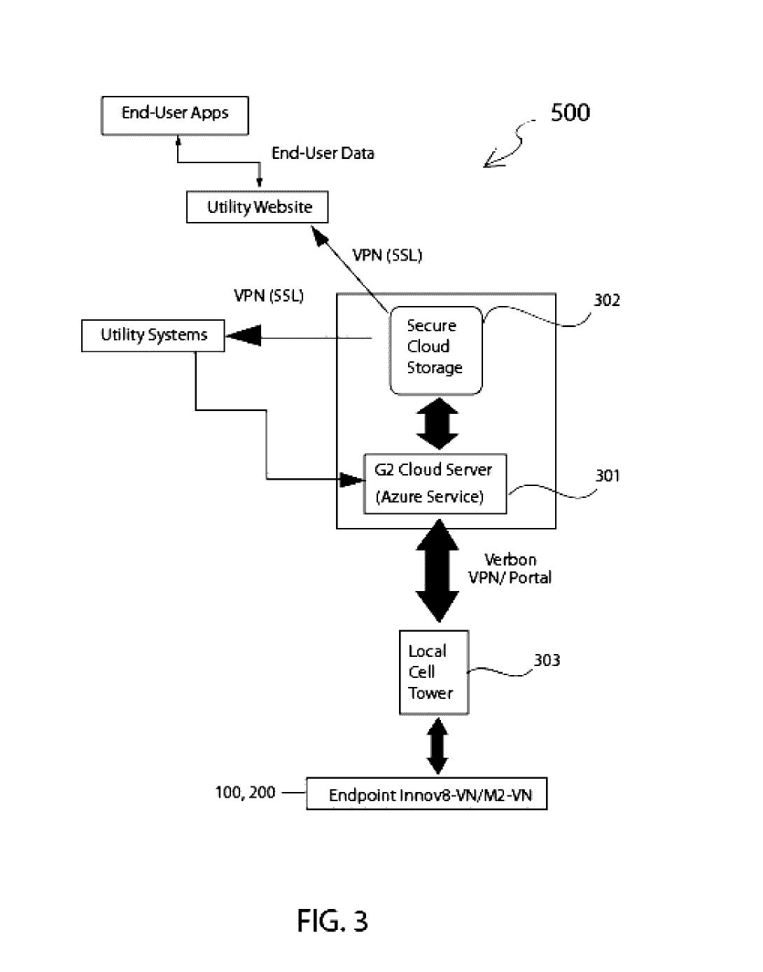

Referring to FIG. 3, this schematic diagram illustrates a wireless system 500 for facilitating utility metering, in accordance with an embodiment of the present disclosure. With respect to data communication, the endpoints, e.g., the devices 100, 200, and the stand-alone modem 400, store interval data and consumption flags in an on-board memory. This interval data and the consumption flags are maintained long term, e.g., weeks to months, based on the data interval selected, to allow for data integrity and redundancy. The endpoints need to transmit their data to a central storage system way of a local cell tower 303. The AMI network, i.e., the backbone of the system 500, comprises a path from the endpoints to a cloud-computing site, such as a cloud server 301. The system 500 may utilize Verizon Wireless®′ nationwide CDMA network as the Verizon® network supports machine-to-machine (M2M) communications applications.

Still referring to FIG. 3, the wireless system 500 comprises: at least one electronic device 100, 200 in communication with at least one server 300, the at least one electronic device 100, 200 comprising: a processor, e.g., a microcontroller 10; a power source, e.g., a power system 60 by way of power electronics 62, in electronic communication with the processor; a feature for wirelessly communicating, e.g., a wireless module 80, the wirelessly communicating feature in electronic communication with the processor, e.g., the microcontroller 10, and the power source, e.g., the power system 60 by way of the power electronics 62; and at least one irrigation feature 199 of a virtual irrigation deduction meter feature (not shown), a residential consumption profile feature (not shown), a residential irrigation profile feature (not shown), and a restricted irrigation compliance monitoring feature (not shown), the at least one irrigation feature 199 in electronic communication with at least one of the processor, e.g., the microcontroller 10, and the power source, e.g., the power system 60 by way of the power electronics 62, the processor, e.g., the microcontroller 10, adapted to control the wirelessly communicating feature, e.g., the wireless module 80, and the at least one irrigation feature 199 in a manner that minimizes water consumption, whereby water (not shown) is conservable, and whereby the electronic device 200 is adapted to serve at least one function. The wirelessly communicating feature, such as the wireless module 80, comprises a cellular feature, e.g., the antenna 430, e.g., an integral antenna, for communicating utility usage data to a server, e.g., a remote server 300, a cloud-based server 301, and a remote cloud-based server (not shown).

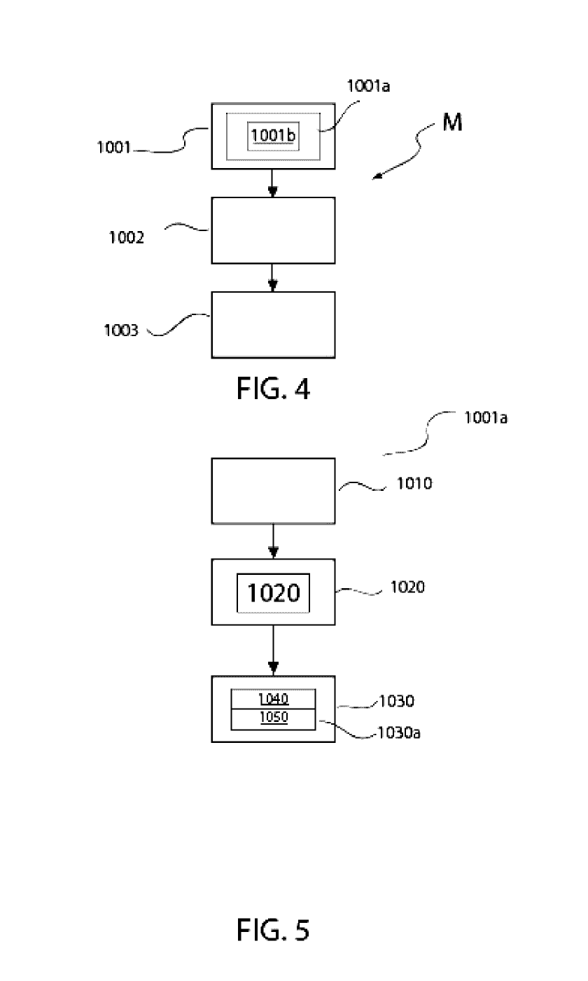

Referring to FIG. 4, this flow diagram illustrates a method M of handling utility usage data by way of a multi-function electronic device, the method M comprising: collecting utility usage data by at least one magnetic-field sensor, as indicated by block 1001; and transmitting the utility usage data to at least one server 50 by a wirelessly communicating feature 30, as indicated by block 1002, wherein the collecting step 1001 comprises utilizing at least one irrigation feature 199 of a virtual irrigation deduction meter feature (not shown), a residential consumption profile feature (not shown), a residential irrigation profile feature (not shown), and a restricted irrigation compliance monitoring feature (not shown), as indicated by block 1001a, wherein the utilizing step 1001a comprises controlling the at least one irrigation feature 199 by the processor, such as the microcontroller 10, as indicated by block 1001b, in a manner that minimizes water consumption, and whereby water (not shown) is conservable, in accordance with an embodiment of the present disclosure. The transmitting step 1002 is performed by the wireless communicator, comprising a cellular feature, for communicating utility usage data to the at least one server. The method M further comprises receiving utility usage data by the at least one server, comprising one of a remote server 300, a cloud-based server 301, a remote cloud-based server (not shown), as indicated by block 1003.

Referring to FIG. 5, this flow diagram illustrates the at least one irrigation feature 199 utilizing step 1001a, comprising: detecting an irrigation water usage, as indicated by block 1010; displaying the irrigation water usage, as indicated by block 1020; and controlling the irrigation water usage, as indicated by block 1030, wherein the irrigation water usage detecting comprises detecting detailed information relating to irrigation water usage, as indicated by block 1030a, and wherein the usage of irrigation water is subject to at least one of a sewer tax and a water use limitation regulation, and thereby facilitating determination of irrigation water usage, in accordance with an embodiment of the present disclosure. The detecting detailed information step 1030a, comprising: at least one of: measuring the irrigation water usage data at sub-hourly intervals, as indicated by block 1040; and measuring the irrigation water usage data at sub-gallon volumes, as indicated by block 1050, thereby providing detected detailed information. The irrigation water usage displaying step 1020 comprises representing data relating to the irrigation water usage in a residential consumption profile in a graphic form, as indicated by block 1021, wherein the graphic form comprises an ordinate representation of at least one parameter of a percentage, a volume, and a currency as a function of an abscissa representation of a at least one time period of a day, a week, a month, and a year.

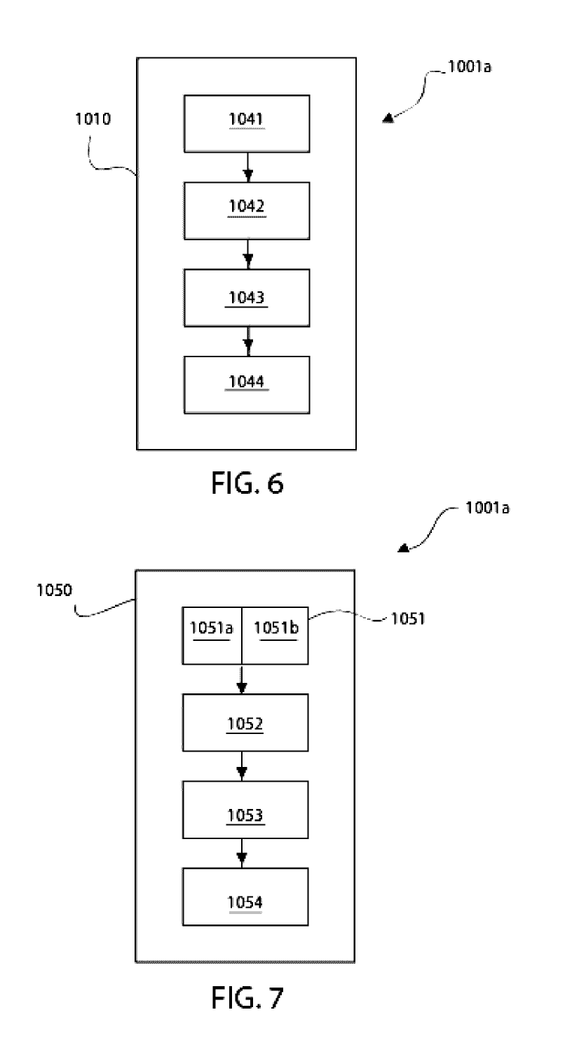

Referring to FIG. 6, this flow diagram illustrates the at least one irrigation feature 199 utilizing step 1001a, alternatively comprising: utilizing the virtual irrigation deduction meter feature, as indicated by block 1040, and wherein the virtual irrigation deduction meter feature utilizing step 1040 comprises: identifying the irrigation water usage from a periodic higher flow rate usage by way of analyzing the detected detailed information, thereby providing data relating to at least one short-interval peak irrigation water usage value, as indicated by block 1041; summing the at least one short-interval peak irrigation water usage value, thereby providing data relating to a total short-interval peak irrigation water usage value, as indicated by block 1042; subtracting any leakage usage value from the total short-interval peak usage value, thereby providing a net irrigation water usage value, as indicated by block 1043; and deducting the net irrigation water usage value from a total meter water usage value, thereby separating a domestic water usage value from an irrigation water usage value, and thereby facilitating implementation of a single water meter for measuring both domestic water usage and irrigation water usage, in accordance with an embodiment of the present disclosure.

Still referring to FIG. 6, with respect to the virtual irrigation deduction meter feature in step 1040, by using short interval data, identifying the irrigation water usage from a periodic higher flow rate usage is possible. This identification of the irrigation water usage is important, because lawns are typically watered for durations in a range less than approximately an hour and possibly watered region-by-region (in relation to portions of the lawn) over different time periods of a day, e.g., in 15-minute intervals at each region of a plurality of regions (imparting data for determining a short-interval peak usage). In the methods of the present disclosure, this short-interval peak usage is summed to provide a total short-interval peak usage value. Any leakage usage is subtracted from the total short-interval peak usage value, thereby providing a net irrigation water usage value. This net irrigation water usage value is deducted from the total meter usage value in order to separate a “domestic” usage value for billing in relation to the items attributed to both “water and sewer” from the “irrigation water” usage for billing in relation to irrigation water usage only. By implementing this method of operating the presently disclosed multi-function electronic devices, and systems, implementation of a single water meter for measuring both domestic water usage as well as irrigation water usage is possible, rather than implementing two separate water meters, otherwise necessitated in the related art.

Referring to FIG. 7, this flow diagram illustrates the at least one irrigation feature 199 utilizing step 1001a, alternatively comprising: utilizing the residential consumption profile feature, as indicated by block 1050, and wherein the residential consumption profile feature utilizing step 1050 comprises: identifying a residential water consumption from a periodic lower flow rate usage by way of analyzing the detected detailed information, thereby providing data relating to at least one short-interval low residential water usage value, as indicated by block 1051, wherein: if the at least one short-interval low residential water usage value is equal to zero, a leak is determined, as indicated by block 1051a, and if the at least one short-interval low residential water usage value is greater than zero, a leak rate is determined, wherein the leak rate comprises a value corresponding to a lowest short-interval low residential water usage value in any interval, normalized to at least one of a daily usage, a weekly usage, and a monthly usage, thereby providing data relating to a leak water usage value, as indicated by block 1051b; summing the at least one short-interval low residential water usage value having a value in a range that is greater than a predetermined threshold flow rate over a predetermined period of time, thereby providing data relating to a total irrigation water usage value, as indicated by block 1052; subtracting any leak water usage value from a total usage value, thereby providing a net combined domestic usage and irrigation usage value, as indicated by block 1053; and deducting the total irrigation water usage value from the net combined domestic usage and irrigation usage value, thereby separating a domestic water usage value from an irrigation water usage value, as indicated by block 1054, thereby facilitating implementation of a single water meter for measuring both domestic water usage and irrigation water usage, in accordance with an embodiment of the present disclosure.

Still referring to FIG. 7, with respect to the residential consumption profile feature in step 1050, a leak is determinable if the measured consumption, during a given interval for a given day, is zero, in accordance with the present disclosure. If no zero usage interval is found, then the “leak rate” is the lowest usage in any interval, normalized to a daily usage, a weekly usage, or a monthly usage. For example, a minimum 5-minute interval usage value of 1 gallon equals a leak rate of 288 gallons per day, 2016 gallons per week, or over 8,000 gallons per month. The irrigation usage is determined by summing the usage, above a predetermined threshold flow rate, over a certain period of time, e.g., a day, a week, or a month, to determine the total irrigation usage. The domestic usage is the total usage through the meter, minus the leak usage, and minus the irrigation usage. A residential consumption profile may be represented in a graphic form, e.g., as a percentage, a volume, or a currency (given a valid utility billing rate), over a certain time period, e.g., a day, a week, a month, or a year).

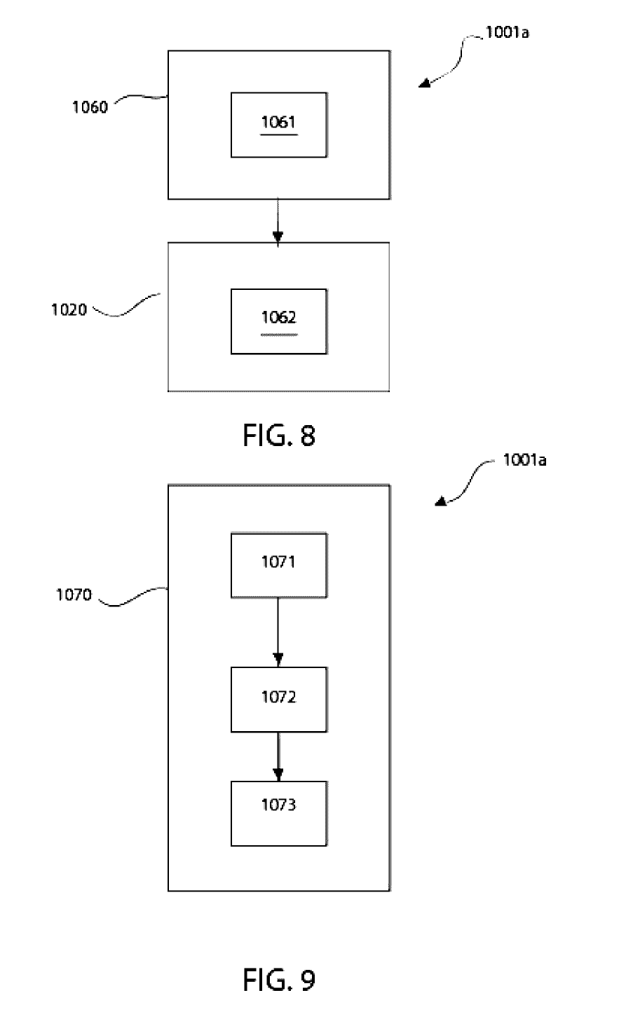

Referring to FIG. 8, this flow diagram illustrates the at least one irrigation feature 199 utilizing step 1001a, alternatively comprising: utilizing a residential irrigation profile feature, as indicated by block 1060, and wherein the residential irrigation profile feature utilizing step 1060 comprises correlating irrigation water usage data in relation to any sprinkler system being active during the at least one sub-hourly interval, thereby providing data relating to water consumption corresponding to at least one portion of a landscape, as indicated by block 1061, wherein the irrigation water usage displaying step 1020 comprises representing data relating to the irrigation water usage in a residential irrigation profile in at least one form of an analog form, a digital form, and a graphic form being registered on a water meter, as indicated by block 1062, and wherein the at least one form comprises a representation of a volume as a function of at least one time period of a sub-hour, an hour, a day, a week, a month, and a year, in accordance with an embodiment of the present disclosure.

Still referring to FIG. 8, with respect to the residential irrigation profile feature in step 1060, water consumers can see a daily, a weekly, or a monthly irrigation water usage being registered on their respective water meters by day, or even by sub-hourly intervals, in accordance with the present disclosure. The residential irrigation profile feature is adapted to correlate data in relation to any sprinkler system being active during these sub-hourly intervals, thereby providing the consumer with information relating to the amount of water being consumed at each location of the consumer's property. This is important to compare assumed sprinkler system programming to actual sprinkler system usage. The irrigation profile can show both irrigation volume (gallons) per day as well as irrigation time (minutes) per day.

Referring to FIG. 9, this flow diagram illustrates the at least one irrigation feature 199 utilizing step 1001a, alternatively comprising: utilizing the restricted irrigation compliance monitoring feature, as indicated by block 1070, and wherein the restricted irrigation compliance monitoring feature utilizing comprises at least one of: monitoring an irrigation profile by comparing the irrigation profile with at least one given restriction, as indicated by block 1071; identifying at least one violator of the at least one given restriction, as indicated by block 1072; and remotely limiting water usage, as indicated by block 1073, in accordance with an embodiment of the present disclosure. The at least one given restriction comprises at least one restriction limiting watering to at least one of at least one certain day of a week, at least one certain time of a day, and a maximum duration per irrigation event.

Still referring to FIG. 9, with respect to the restricted irrigation compliance monitoring feature in step 1070, this feature facilitates compliance with the plethora of regulations that are imposed by water utility companies for decreasing total water usage. Examples of such restrictions include, but are not limited to, limiting irrigation to certain days of the week, to certain times of the day, or to a maximum duration per irrigation event. Compliance with any of these restrictions is monitored via the restricted irrigation compliance monitoring feature by comparing the above irrigation profile to a given restriction. Further, the restricted irrigation compliance monitoring feature is adapted to identify violators of such restrictions for facilitating their penalization. Additionally, irrigation usage may be limited remotely, thereby eliminating the need for a service person to manually limit the water usage.

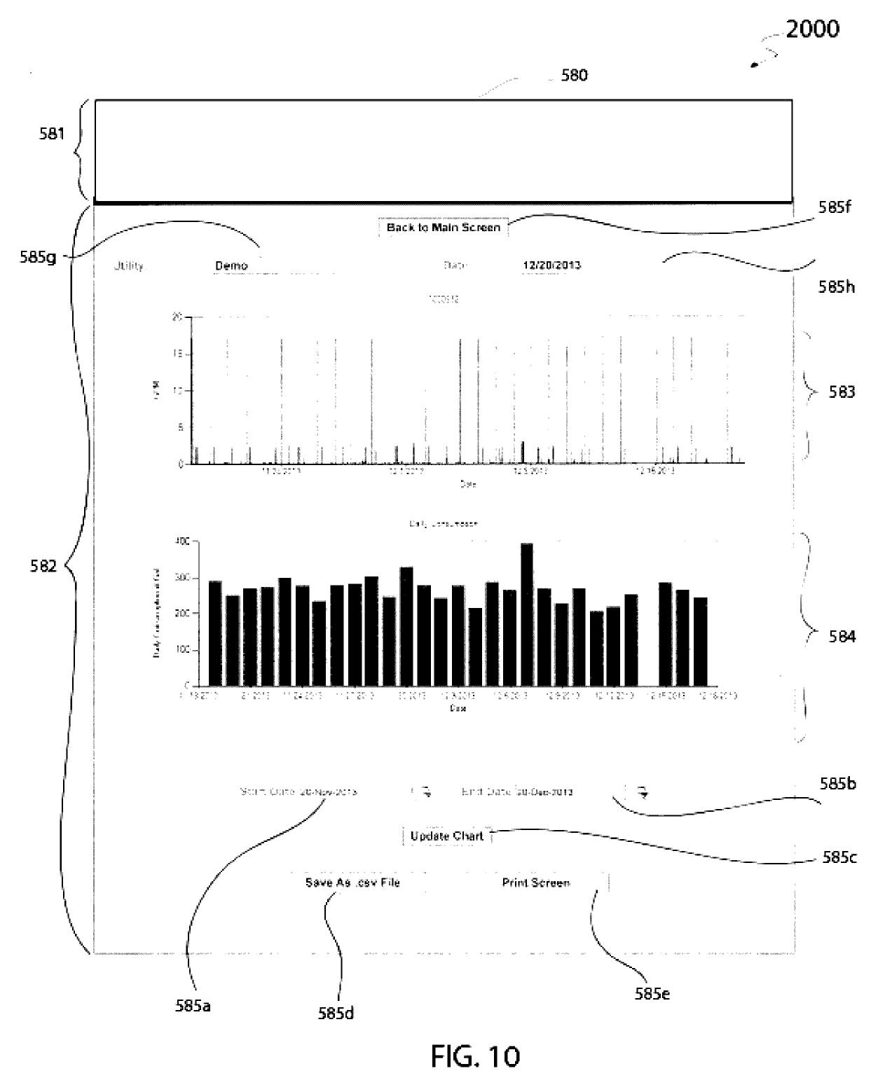

Referring to FIG. 10, this screenshot illustrates a graphic user interface 2000, comprising a display 580 of meter history information, in accordance with an embodiment of the present disclosure. The display 580 comprises a header 581 and a body 582. The header 581 displays identifying information relating to software that is used for performing a set of executable instructions. The body 582 displays at least one graph, each at least one graph comprising at least one format, such as a linear graph format and a bar graph format. By example only, the at least one graph comprises at least one of: a linear graph 583, displaying water consumption data in units of gallons per minute (GPM) as a function of time, e.g., in units of continuous days (DATE); and a bar graph 584, displaying daily water consumption data in units of gallons (Gal.) as a function of time, e.g., in units of day intervals (DATE). The body 582 further comprises at least one interactive feature, such as a start date field 585a, an end date field 585b, an update chart button 585c, a save-as button 585d, a print screen button 585e, a back-to-main-screen button 585f, a utility identification field 585g, and a date field 585h.

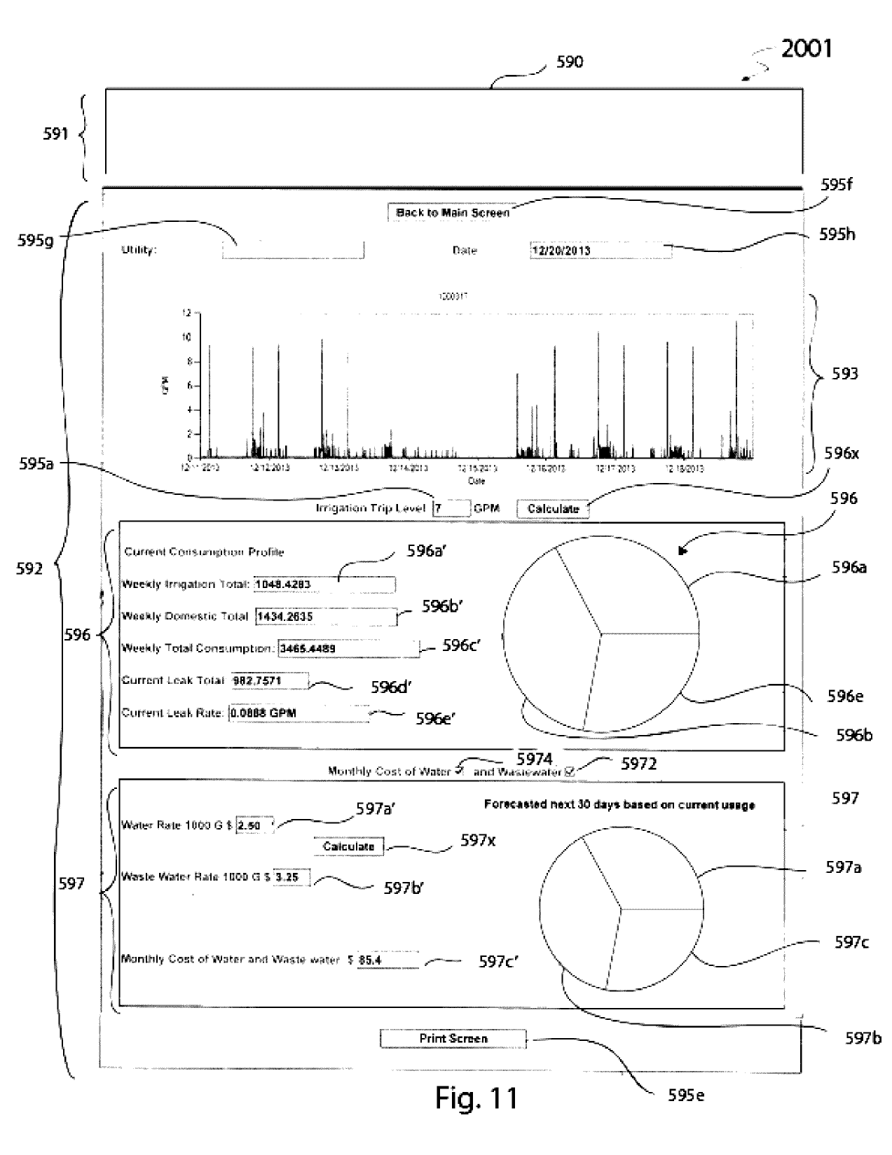

Referring to FIG. 11 is a screenshot illustrating a graphic user interface 2001, comprising a display 590 of consumption analysis information, in accordance with an embodiment of the present disclosure. The display 590 comprises a header 591 and a body 592. The header 591 displays identifying information relating to software that is used for performing a set of executable instructions. The body 592 displays at least one graph, each at least one graph comprising at least one format, such as a linear graph format and a pie chart format.

Still referring to FIG. 11, by example only, the at least one graph comprises at least one feature, such as a linear graph 593, displaying water consumption data in units of gallons per minute (GPM) as a function of time, e.g., in units of continuous days (DATE); a first pie chart 596, displaying a current water consumption profile 596′ in terms of weekly water consumption data in units of percentage of a total water consumption, such as a percentage of the total water consumption that is attributed to irrigation, as indicated by a sector 596a, a percentage of the total water consumption that is attributed to domestic use, as indicated by a sector 596b, and a percentage of the total water consumption that is attributed to leaks, as indicated by a sector 596c, wherein the current consumption profile 596′ includes a display of at least one data field relating to a weekly irrigation total value (gallons), as indicated by field 596a′, a weekly domestic use total value (gallons), as indicated by field 596b′, a weekly total consumption (gallons), as indicated by field 596c′, a current leak total value (gallons), as indicated by field 596d′, and a current leak total rate (GPM), as indicated by field 596e′.

Still referring to FIG. 11, by example only, the at least one graph also comprises at least one feature, such as a second pie chart 597, displaying monthly water cost data 597′ in terms of billing cost for a total water consumption, such as a billing cost (dollars for example) of the total water consumption that is attributed to irrigation, as indicated by a sector 597a, a billing cost of the total water consumption that is attributed to domestic use, as indicated by a sector 597b, and a billing cost of the total water consumption that is attributed to leaks, as indicated by a sector 597c, wherein the monthly water cost data 597′ includes a display of at least one data field relating to a water billing rate per unit water volume, as indicate by field 597a′, a waste water billing rate per unit water volume, as indicate by field 597b′, and a monthly billing cost attributed to both water consumption and waste water, as indicated by field 597c′. The body 592 further comprises at least one interactive feature, such as an irrigation trip level field 595a, a calculate button 596x for calculating the current consumption profile 596′, a calculate button 597x for calculating the monthly water cost 597′, a monthly water cost toggle button 597y, a monthly water cost toggle button 597z, a print screen button 595e, a back-to-main-screen button 595f, a utility identification field 595g, and a date field 595h.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. A method of handling utility usage data by way of a multi-function electronic device, the method comprising:
collecting utility usage data by at least one magnetic-field sensor; and
transmitting the utility usage data to at least one server by a wireless communicator;
wherein the collecting step comprises utilizing at least one irrigation feature of a virtual irrigation deduction meter feature, a residential consumption profile feature, a residential irrigation profile feature, and a restricted irrigation compliance monitoring feature,
wherein the at least one irrigation feature utilized comprises controlling the at least one irrigation feature by the processor in a manner that minimizes water consumption, and
whereby water is conservable.

2. The method of claim 1, wherein the transmitting step is performed by the wireless communicator, comprising a cellular feature, for communicating utility usage data to the at least one server.

3. The method of claim 1, further comprising receiving utility usage data by the at least one server, comprising one of a remote server, a cloud-based server, and a remote cloud-based server.

4. The method of claim 1, wherein the utilizing step comprises:
detecting an irrigation water usage;
displaying the irrigation water usage; and
controlling the irrigation water usage.

5. The method of claim 4,
wherein the irrigation water usage detecting comprises detecting detailed information relating to irrigation water usage, and
wherein the usage of irrigation water is subject to at least one of a sewer tax and a water use limitation regulation,
thereby facilitating determination of irrigation water usage.

6. The method of claim 5, wherein the detailed information detecting comprises at least one of:
measuring the irrigation water usage data at sub-hourly intervals;
measuring the irrigation water usage data at sub-gallon volumes,
thereby providing detected detailed information.

7. The method of claim 6,
wherein the at least one irrigation feature utilizing comprises utilizing the virtual irrigation deduction meter feature, and
wherein the virtual irrigation deduction meter feature utilized comprises:
identifying the irrigation water usage from a periodic higher flow rate usage by way of analyzing the detected detailed information, thereby providing data relating to at least one short-interval peak irrigation water usage value;
summing the at least one short-interval peak irrigation water usage value, thereby providing data relating to a total short-interval peak irrigation water usage value;
subtracting any leakage usage value from the total short-interval peak usage value, thereby providing a net irrigation water usage value; and
deducting the net irrigation water usage value from a total meter water usage value, thereby separating a domestic water usage value from an irrigation water usage value, thereby facilitating implementation of a single water meter for measuring both domestic water usage and irrigation water usage.

8. The method of claim 6,
wherein the at least one irrigation feature utilized comprises utilizing the residential consumption profile feature, and
wherein the residential consumption profile feature utilized comprises:
identifying a residential water consumption from a periodic lower flow rate usage by way of analyzing the detected detailed information, thereby providing data relating to at least one short-interval low residential water usage value, wherein:
if the at least one short-interval low residential water usage value is equal to zero, a leak is determined, and
if the at least one short-interval low residential water usage value is greater than zero, a leak rate is determined, wherein the leak rate comprises a value corresponding to a lowest short-interval low residential water usage value in any interval, normalized to at least one of a daily usage, a weekly usage, and a monthly usage, thereby providing data relating to a leak water usage value;
summing the at least one short-interval low residential water usage value having a value in a range that is greater than a predetermined threshold flow rate over a predetermined period of time, thereby providing data relating to a total irrigation water usage value;
subtracting any leak water usage value from a total usage value, thereby providing a net combined domestic usage and irrigation usage value; and
deducting the total irrigation water usage value from the net combined domestic usage and irrigation usage value, thereby separating a domestic water usage value from an irrigation water usage value,
thereby facilitating implementation of a single water meter for measuring both domestic water usage and irrigation water usage.

9. The method of claim 8,
wherein the irrigation water usage displaying comprises representing data relating to the irrigation water usage in a residential consumption profile in a graphic form, and
wherein the graphic form comprises an ordinate representation of at least one parameter of a percentage, a volume, and a currency as a function of an abscissa representation of a at least one time period of a day, a week, a month, and a year.

10. The method of claim 6,
wherein the at least one irrigation feature utilized comprises utilizing the residential irrigation profile feature, and
wherein the residential irrigation profile feature utilizing comprises correlating irrigation water usage data in relation to any sprinkler system being active during the at least one sub-hourly interval, thereby providing data relating to water consumption corresponding to at least one portion of a landscape,
wherein the irrigation water usage displaying comprises representing data relating to the irrigation water usage in a residential irrigation profile in at least one form of an analog form, a digital form, and a graphic form being registered on a water meter, and
wherein the at least one form comprises a representation of a volume as a function of at least one time period of a sub-hour, an hour, a day, a week, a month, and a year.

11. The method of claim 6,
wherein the at least one irrigation feature utilized comprises utilizing the restricted irrigation compliance monitoring feature, and
wherein the restricted irrigation compliance monitoring feature utilizing comprises at least one of:
monitoring an irrigation profile by comparing the irrigation profile with at least one given restriction;
identifying at least one violator of the at least one given restriction; and
remotely limiting water usage.

12. The method of claim 11, wherein the at least one given restriction comprises at least one restriction limiting watering to at least one of at least one certain day of a week, at least one certain time of a day, and a maximum duration per irrigation event.

13. An electronic device, comprising:
a processor;
a power source in electronic communication with the processor;
at least one magnetic-field sensor in electronic communication with the processor; and
at least one irrigation feature of a virtual irrigation deduction meter feature, a residential consumption profile feature, a residential irrigation profile feature, and a restricted irrigation compliance monitoring feature, the at least one irrigation feature in electronic communication with the processor and the power source,
the processor adapted to control the at least one irrigation feature in a manner that minimizes water consumption,
whereby water is conservable, and
whereby the electronic device being adapted to serve at least one function.

14. The device of claim 13, further comprising means for wirelessly communicating, the wirelessly communicating means in electronic communication with the processor and the power source, the processor controlling the wirelessly communicating means.

15. The device of claim 14, wherein the wirelessly communicating means comprises a cellular feature for communicating utility usage data to at least one of a server, a remote server, a cloud-based server, and a remote cloud-based server.

16. The device of claim 13, wherein the at least one function comprises a register device function and a remote device function.

17. The device of claim 14,
wherein the wirelessly communicating means is adapted to receive data, and
wherein the wirelessly communicating means is adapted to effect a fluid shut-off.

18. The device of claim 13, wherein the at least one magnetic-field sensor is adapted to perform at least one sensor function of:
performing an accurate reading of at least one parameter of a utility usage, a fluid usage, and a water usage;
performing a high resolution detection of water usage by performing frequent accurate readings, whereby performance of a metering body is enhanced; and
detecting at least one indication of a high flow, low flow, consistent flow, inconsistent flow, non-flow, back-flow, tampering of the metering body, and removal of the metering body.

19. The device of claim 13, wherein the processor executes a software program, using data provided by the at least one magnetic-field sensor, for identifying at least one utility usage pattern.
